(19) United States
(12) Patent Application Publication
(10) Pub. No.: US 2025/0270416 A1
(43) Pub. Date: Aug. 28, 2025

(54) BASE PAINT COMPOSITION

(71) Applicant: KCC CORPORATION, Seoul (KR)

(72) Inventors: Sejun SHIN, Busan (KR); Soonkyu PARK, Ulsan (KR); Hyo-Chang KIM, Daegu (KR); Soon Jong PARK, Ulsan (KR)

(21) Appl. No.: 18/857,469

(22) PCT Filed: Apr. 26, 2023
(86) PCT No.: PCT/KR2023/005681

§ 371 Date: Oct. 17, 2024

(30) Foreign Application Priority Data
Jun. 10, 2022 (KR) 10-2022-0071017

(51) Int. Cl. C09D 101/18; C09D 7/40; C09D 7/61

(52) U.S. Cl. CPC C09D 101/18; C09D 7/61; C09D 7/70

(57) ABSTRACT

Provided is a base paint composition comprising an acrylic polyol resin, a polyester resin, a nitrocellulose resin, and a pigment. Provided base coating composition which has a better metallic texture than a typical metallic coating, implements a variety of luxurious colors, enables spray coating on a part having a large area and a complex shape among automobile parts, thereby having excellent workability and mass productivity, and has an excellent appearance, especially implementing a metallic texture.

### TECHNICAL FIELD

This application claims the benefit of Korean Patent Application No. 10-2022-0071017, filed on Jun. 10, 2022, in the Korean Intellectual Property Office, the disclosure of which is incorporated herein in its entirety by reference.

The present invention relates to a base coating composition which has excellent metal texture, enables spray coating on a part having a large area and a complex shape among automobile parts, such as a roof rack bars and a skid plate, enables implementation of a metallic textured appearance, and has excellent physical properties such as adhesion, water resistance, weather resistance, and car-wash properties.

### BACKGROUND ART

As the demand of customers for emotional quality of automobiles has increased, automobile manufacturers are using techniques such as coating a metallic coating, or plating or depositing the same on a substrate to implement a luxurious metallic texture. At this time, the plating or deposition technique has limitations in implementing various colors, and has limitations in high cost and production volume, and during the process, there is a problem in that wastewater that causes environmental pollution is produced. In addition, a typical metallic coating is low in luminance and metallic texture, and thus, has limitations in implementing a design luxurious enough to satisfy customers demanding for emotional quality.

In response to this, Korean Patent No. 10-1843288 (Patent Document 1) discloses a coating composition including a base coat primary color including an aluminum paste, polyether, cellulose acetate butyrate (CAB) having a molecular weight of 25,000 g/mol to 35,000 g/mol, a polyester resin, a polyamide wax, a polyolefin wax, and a solvent, and a transparent for adjusting a base coat. However, the coating composition of Patent Document 1 above has a problem in that it is difficult to implement a metallic texture due to degradation in luminance over time, and stains and the like are generated.

Therefore, there is a need for coating technology which is excellent in implementing a metallic texture compared to a typical metallic coating, implements a variety of luxurious colors, and achieves economic feasibility and mass productivity. In addition, there is a need for a metallic coating which is excellent in various physical properties such as water resistance, weather resistance, high-pressure car-wash properties, chipping resistance, acid/alkali resistance, and accelerated weather resistance after coating, and which enables spray coating on a part having a large area and a complex shape among automobile parts, such as a roof rack bars and a skid plate.

### DISCLOSURE OF THE INVENTION

### Technical Problem

The present invention is to provide a base coating composition which has a better metallic texture than a typical metallic coating, implements a variety of luxurious colors, enables spray coating on a part having a large area and a complex shape among automobile parts, thereby having excellent workability and mass productivity, and has an excellent appearance, especially implementing a metallic texture.

### Technical Solution

In order to achieve the above-described objective, the present invention provides a base coating composition including an acrylic polyol resin, a polyester resin, a nitrocellulose resin, and a pigment.

### Advantageous Effects

Abase coating composition according to the present invention enables spray coating on a large-area complex shape, and thus, has excellent workability and mass productivity, which makes the base coating composition very suitable for coating automobile parts. Furthermore, the base coating composition is capable of implementing various luxurious colors, and may form a coating film having higher luminance than a typical metallic coating has.

In addition, the coating film manufactured from the base coating composition is excellent in various physical properties, such as water resistance, weather resistance, high-pressure car-wash properties, chipping resistance, acid resistance, alkali resistance, and accelerated weather resistance. Particularly, the coating film manufactured from the base paint composition has very excellent appearance characteristics due to less occurrence of appearance defects such as metallic stains or foreign substances.

### BEST MODE FOR CARRYING OUT THE INVENTION

Hereinafter, the present invention will be described in detail.

In the present invention, the “number average molecular weight (Mn)” and the “weight average molecular weight (Mw)” may be measured by methods well known in the art, and may be values measured by a gel permeation chromatograph (GPC) method.

In addition, a functional value such as the “hydroxyl group” may be measured by a method well known in the art, and may be measured by, for example, a titration method or the like.

The “glass transition temperature” is measured by a typical method known in the art, and may be measured by, for example, a differential scanning calorimetry (DSC) method.

A base coating composition according to the present invention includes an acrylic polyol resin, a polyester resin, a nitrocellulose resin, and a pigment.

### Acrylic Polyol Resin

The acrylic polyol resin is a main resin of a coating including the same, and serves to form a coating film and determine characteristics of the coating film.

The acrylic polyol resin may be directly synthesized according to a known method, or a commercially available product may be used. At this time, the acrylic polyol resin may be prepared by, for example, polymerizing a hydroxyl group-containing acrylic monomer and a vinyl monomer, or polymerizing a hydroxyl group-containing acrylic monomer.

The hydroxyl-containing acryl monomer may be for example, hydroxyalkyl-containing (meth)acrylate, and specifically, may include one or more selected from the group consisting of 2-hydroxymethyl (meth)acrylate, 2-hydroxyethyl (meth)acrylate, 2-hydroxypropyl (meth)acrylate, 2-hydroxybutyl (meth)acrylate, 1,3-butanediol di(meth)acrylate, 1,4-butanediol di(meth)acrylate, ethylene glycol di(meth)acrylate, and 1,6-hexanediol di(meth)acrylate.

The vinyl monomer may be, for example, (meth)acrylate substituted or unsubstituted with a hydroxyl group, and specifically, may include one or more selected from the group consisting of (meth)acrylic acid, methyl (meth)acrylic acid, methyl (meth)acrylate, ethyl (meth)acrylate, isobutyl (meth)acrylate, n-butyl (meth)acrylate, t-butyl (meth)acrylate, n-hexyl (meth)acrylate, cyclohexyl (meth)acrylate, 2-ethylhexyl (meth)acrylate, n-octyl (meth)acrylate, isobornyl (meth)acrylate, styrene, methylstyrene, dimethylstyrene, fluorostyrene, ethoxystyrene, and methoxystyrene.

The above-described acrylic polyol resin may be a cellulose acetate butyrate (CAB)-modified acrylic resin. If the cellulose acetate butylate-modified acrylic resin is used as the acrylic polyol resin, the modification is performed with cellulose acetate butylate, which is a polymer, so that the dryness of a coating containing the same is improved, resulting in achieving an effect of improving the luminance of a metallic base coating. A cellulose acetate butylate resin is in a powder form, and thus, if included alone, the cellulose acetate butylate resin is not sufficiently dissolved in a solvent, which may lead to degradation of appearance characteristics of a manufactured coating film, such as forming irregularities, so that it is more preferable that the cellulose acetate butylate resin is modified and included in an acrylic resin.

Typically, a coating film formed by applying a coating is dried while a solvent is volatilized, and during this process, the coating film contracts. As the content of the solvent increases, the shrinkage rate of the coating film increases, and force generated during the contraction process affects the arrangement of an aluminum pigment, which may increase luminance. For example, in the case of a polymer resin modified with cellulose acetate butyrate, such as the acrylic polyol resin, the viscosity is high, so that a large amount of solvent is contained for workability, and a coating film manufactured from a coating including the corresponding resin has an effect of improving luminance due to the contraction of the coating film while being dried.

Specifically, the acrylic polyol resin may have a content of cellulose acetate butyrate of 3 wt % to 15 wt %, or 5 wt % to 10 wt %, based on the total weight of the resin. If the CAB content to the total weight of the acrylic polyol resin is in the above-described range, there is an effect of improving spray workability and dryness of a coating composition. In addition, if the content of the cellulose acetate butyrate is less than the above-described range, the acrylic polyol resin has a decreased molecular weight (Mw), resulting in an insufficient effect of improving dryness and luminance of a coating composition, and if greater than the above-described range, the viscosity increases due to the cellulose acetate butyrate, so that there may be problems in which the solid volume ratio (SVR) of a coating decreases and the appearance of a manufactured coating film is poor.

The acrylic polyol resin may have a hydroxyl value (OHv) of 30 mgKOH/g to 80 mgKOH/g, 30 mgKOH/g to 60 mgKOH/g, or 40 mgKOH/g to 60 mgKOH/g. If the hydroxyl value of the acrylic polyol resin is in the above-described range, there are effects of improving the weather resistance of a manufactured coating film, and improving storage properties of a coating and appearance characteristics of the coating film. In addition, if the hydroxyl value of the acrylic polyol resin is less than the above-described range, the number of sites reacting with an isocyanate curing agent decreases, resulting in degrading a cross-linking density, so that there may be a problem in that the appearance characteristics, heat resistance, chemical resistance, and the like of a coating film are degraded, and if greater than the above-described range, the number of sites reacting with the isocyanate curing agent is excessively large, resulting in over-curing, so that a coating film becomes brittle, thereby having reduced elasticity, and there may be a problem in that the storage stability, appearance characteristics, and weather resistance of a coating may be degraded.

In addition, the acrylic polyol resin may have an acid value (Av) of 1 mgKOH/g to 10 mgKOH/g, or 5 mgKOH/g to 10 mgKOH/g. If the acid value of the acrylic polyol resin is in the above-described range, there is an effect of improving the dispersion stability and storage stability of a coating composition, and improving the durability of a coating film. In addition, if the acid value of the acrylic polyol resin is less than the above-described range, a urethane reaction is accelerated, resulting in accelerating a curing reaction, and accordingly, there may be a problem in that pot life is reduced and appearance characteristics of a coating film are degraded, and if greater than the above-described range, the urethane reaction is excessively delayed, resulting in increasing the pot life, so that there may be a problem in that drying is slowed and workability is degraded.

The acrylic polyol resin may have a glass transition temperature (Tg) of about 1° C. to 20° C., or 1° C. to 5° C. If the glass transition temperature of the acrylic polyol resin is in the above-described range, there is an effect of improving coating-film formability and anti-foaming properties of a composition, and gloss properties of a coating film. In addition, if the glass transition temperature of the acrylic polyol resin is lower than the above-described range, a coating film becomes more flexible, resulting in decreasing a drying rate of a coating composition, so that there may be a problem in that the appearance, anti-sagging property, and chemical resistance of the coating film are degraded, and if higher than the above-described range, there may be a problem in that a coating film becomes brittle, thereby degrading appearance characteristics.

In addition, the acrylic polyol resin may have a weight average molecular weight (Mw) of 100,000 g/mol to 200,000 g/mol, or 100,000 g/mol to 150,000 g/mol. If the weight average molecular weight of the acrylic polyol resin is in the above-described range, the hardness of a manufactured coating film maybe improved. In addition, if the weight average molecular weight of the acrylic polyol resin is less than the above-described range, the molecular weight of the resin is small, so that there may be a problem in that the acid resistance and chemical resistance of a manufactured coating film are degraded, and if greater than the above-described range, flowability and leveling properties of a coating composition are degraded due to an increase in the molecular weight of the resin, so that there may be a problem in that the appearance and mechanical properties of the coating film are degraded.

The acrylic polyol resin may be included in an amount of 5 wt % to 15 wt %, or 5 wt % to 12 wt %, based on the total weight of the base coating composition. If the acrylic polyol resin is included in the above-described content range, there is an effect of improving the adhesion and impact resistance of a coating film. In addition, if the content of the acrylic polyol resin is less than the above-described range, coating-film build-up property may be reduced and the adhesion and durability of a coating film may be reduced due to a lack in interface attachment sites, and if greater than the above-described range, the viscosity of a coating composition increases due to a large amount of the acrylic polyol resin having a high viscosity, so that storage stability may be degraded.

### Polyester Resin

The polyester resin is an auxiliary resin of the paint composition including the same, and serves to prevent metallic stains and appearance defects by improving spreadability and dryness of a coating film.

The polyester resin may be directly synthesized according to a known method, or a commercially available product may be used. For example, the polyester resin may be a polymer produced by a condensation reaction between a polyol monomer and a carboxyl group-containing monomer. Specifically, the polyester resin may be prepared by a condensation reaction between a polyol monomer and an aliphatic monomer containing a carboxyl group.

The polyol monomer may be, for example, ethylene glycol, propylene glycol, trimethylolpropane, trimethylolethane, cyclohexanedimethanol, neopentyl glycol, 2-butyl-2-ethyl-1,3-propanediol, 1,4-hexanediol, 1,6-hexanediol, diethylene glycol, dipropylene glycol, triethylene glycol, tripropylene glycol, 1,2-ethanediol, 1,4-butanediol, 1,3-butanediol, 1,5-pentanediol, triethylolpropane, glycerin, pentaerythritol, 3-methylpentanediol, and a mixture thereof.

In addition, the carboxyl group-containing monomer may be, for example, adipic acid, trimellitic anhydride, terephthalic acid, fumaric acid, phthalic anhydride, hexahydrophthalic anhydride, methylhexahydrophthalic anhydride, tetrahydrophthalic anhydride, methyltetrahydrophthalic anhydride, succinic anhydride, isophthalic acid, azelaic acid, maleic anhydride, and a mixture thereof.

The polyester resin may have a number average molecular weight (Mn) of 800 g/mol to 5,000 g/mol, or 1,000 g/mol to 3,000 g/mol. If the number average molecular weight of the polyester resin is in the above-described range, a coating film is stably formed, so that there is an effect of improving the smoothness of a coating. In addition, if the number average molecular weight of the polyester resin is less than the above-described range, an unreacted urethane group is present due to insufficient heat (temperature) required for a urethane reaction, so that mechanical properties of a coating film may be degraded, and if greater than the above-described range, spreadability and dryness of a coating may be degraded.

In addition, the polyester resin may have a glass transition temperature (Tg) of 0° C. or lower, or −30° C. to 0° C. If the glass transition temperature of the polyester resin is in the above-described range, it is possible to manufacture a coating film having excellent spreadability of a coating and high luminance, and it is possible to reduce the foreign body sensation of the coating film by improving the dryness of the coating. On the other hand, if the glass transition temperature of the polyester resin is less than the above-described range, there is a problem in that the dryness of a coating film is insufficient, which may cause a problem in that physical properties of the coating film, such as scratches and pencil hardness, are insufficient, and if greater than the above-described range, an effect of improving the dryness and spreadability of a manufactured coating film may be insufficient.

The polyester resin may have an acid value (Av) of 1 mgKOH/g to 30 mgKOH/g, or 1 mgKOH/g to 10 mgKOH/g. If the acid value of the polyester resin is in the above-described range, there is an effect of improving the hardness and appearance characteristics of a manufactured coating film. In addition, if the acid value of the polyester resin is out of the above-described range, the polyester resin has an insufficient molecular weight, which may lead to a decrease in the degree of curing of a coating, thereby preventing a coating film from being properly formed, and there may be a problem in which the appearance characteristics of a coating film are degraded due to insufficient storage properties of the coating.

In addition, the polyester resin may have a hydroxyl value (OHv) of 100 mgKOH/g to 200 mgKOH/g, or 120 mgKOH/g to 150 mgKOH/g. If the hydroxyl value of the polyester resin is in the above-described range, there is an effect of improving the durability and chipping resistance of a manufactured coating film, and improving storage properties and appearance characteristics of a coating. In addition, if the hydroxyl value of the polyester resin is less than the above-described range, there may be a problem in that the durability and chemical resistance of a manufactured coating film are degraded due to an insufficient cross-linking density, and if greater than the above-described range, there may be a problem in that the water resistance, pencil hardness, accelerated weather resistance, and the like of a coating film are degraded due to insufficient dryness of a coating composition.

The polyester resin may be included in an amount of 1 wt % to 20 wt %, or 1 wt % to 10 wt %, based on the total weight of the base coating composition. If the content of the polyester resin is in the above-described range, there is less occurrence of metallic stains, paint spreading, foreign body sensation, and the like, so that appearance characteristics are excellent and the workability of the coating composition is excellent. If the content of the polyester resin is less than the above-described range, there may be the occurrence of the foreign body sensation and metallic stains of a manufactured coating film. In addition, if the content of the polyester resin is greater than the above-described range, the luminance of a manufactured coating film may be insufficient.

In addition, the base coating composition may include a polyester resin, an acrylic polyol resin, and a nitrocellulose resin in the composition at a weight ratio of 1:1:5 to 1:4:20. If the weight ratio of the polyester resin, the acrylic polyol resin, and the nitrocellulose resin is out of the above-described range, the luminance of a coating film may be reduced and the workability of the coating composition may become poor. For example, when the content of the polyester resin is increased and the content of the acrylic polyol resin and the content of the nitrocellulose resin are insufficient, the luminance of a manufactured coating film may be decreased. If the content of the polyester and the content of the nitrocellulose resin are insufficient and the content of the acrylic polyol resin is increased, the drying rate of a coating increases, thereby increasing stains and foreign body sensation of a coating film, so that appearance characteristics may be degraded. If the content of the polyester resin and the content of the acrylic polyol resin are insufficient and the content of the nitrocellulose resin is increased, a coating film may have metallic stains, and may have poor physical properties, such as accelerated weather resistance, and water resistance.

### Nitrocellulose Resin

The nitrocellulose resin serves to implement high luminance of a coating film and reduce metallic stain defects by improving the orientation of aluminum, which is a pigment.

In addition, the nitrocellulose resin may be directly synthesized according to a known method, or a commercially available product may be used. The nitrocellulose resin may be used by mixing nitrocellulose in a powder type with a solvent, such as methyl isobutyl ketone (MIBK), ethanol, or toluene. At this time, the nitrocellulose resin may have a nitrocellulose weight of 2 wt % to 10 wt %, or 4 wt % to 7 wt %. If the weight of nitrocellulose in the nitrocellulose resin satisfies the above-described range, a coating film may exhibit high luminance. On the other hand, if the range of nitrocellulose in the nitrocellulose resin is less than the above-described range, the orientation of aluminum may be degraded, which may lead to degradation in luminance of a coating film, and if greater than the above-described range, the nitrocellulose resin having a high molecular weight may be excessively included, resulting in increasing the viscosity of a coating, so that there may be a problem in that the coating is not dissolved well in a solvent.

The nitrocellulose resin may have a weight average molecular weight (Mw) of 100,000 g/mol to 500,000 g/mol, or 200,000 g/mol to 400,000 g/mol. If the weight average molecular weight of the nitrocellulose resin is in the above-described range, there are effects in that a coating film has increased luminance, has excellent appearance characteristics, and has excellent coating workability of a coating. In addition, if the weight average molecular weight of the nitrocellulose resin is less than the above-described range, the luminance of a coating film may be degraded, and if greater than the above-described range, the luminance of a coating film may be insufficient and the coating workability of a coating may be insufficient, so that there may be the occurrence of defects, such as spots and foreign substances of the coating film, and metallic stains.

In addition, the nitrocellulose resin may have a number average molecular weight (Mn) of 10,000 g/mol to 50,000 g/mol, or 20,000 g/mol to 40,000 g/mol. When the number average molecular weight of the nitrocellulose resin is in the above-described range, there are effects in that a coating film having high luminance may be implemented, appearance characteristics of the coating film may be improved, and the coating workability of a paint is excellent. In addition, when the number average molecular weight of the nitrocellulose resin is less than the above-described range, the luminance value of a coating film may be insufficient, and if greater than the above-described range, the luminance value of a coating film may be insufficient, and the coating workability of a coating may be reduced, so that there may be the occurrence of appearance defects such as spots/foreign substances, and metallic stains.

The nitrocellulose resin may be included in an amount of 30 wt % to 60 wt %, or 40 wt % to 60 wt %, based on the total weight of the base coating composition. If the content of the nitrocellulose resin is in the above-described range, there is an effect of improving the appearance, heat resistance, and texture of a manufactured coating film. In addition, when the content of the nitrocellulose resin is less than the above-described range, there may be a problem in that the luminance of a manufactured coating film is low, and if greater than the above-described range, the spreadability of a coating may be degraded due to an excessive amount of the nitrocellulose resin.

### Pigment

The pigment serves to impart a metallic texture to a manufactured coating film and impart various colors thereto. At this time, the above-described pigment may include, for example, an aluminum-based pigment.

The aluminum-based pigment may have a cylindrical columnar or polygonal columnar shape. At this time, the aluminum-based pigment may have a height of 10 m to 150 m or 20 m to 100 m. If the height of the aluminum-based pigment is less than the above-described range, a manufactured coating film has insufficient weather resistance, and thus, discolored, and if greater than the above-described range, a coating film has insufficient luminance and insufficient metallic sensation.

In addition, the aluminum-based pigment may have an average diameter of 1 m to 15 m or 6 m to 10 km. At this time, if the aluminum-based pigment has a polygonal columnar shape, the average diameter at base may be the average diameter of circumscribed circle of a polygon at base. If the average diameter of the aluminum-based pigment is less than the above-described range, opacity may be deteriorated, thereby causing a problem in which a substrate is exposed to the outside, and if greater than the above-described range, there is a problem in that it is difficult to implement a metallic texture.

The content of the pigment may be suitably adjusted based on a target color and target opacity of a coating film, and for example, the pigment may be included in an amount of 1 wt % to 15 wt %, or 5 wt % to 13 wt %, based on the total weight of the base coating composition.

The base coating composition may further include a solvent.

### Solvent

The solvent serves to control the thickness of a coating film and improve coating-film workability of the composition.

At this time, the solvent may include one or more selected from the group consisting of a non-polar solvent and a polar solvent. The solvent may include, for example, one or more selected from the group consisting of dimethyl glutarate, dimethyl succinate, dimethyl adipate, n-heptane, n-hexane, n-butanol, toluene, ethyl acetate, n-butyl acetate, isobutyl acetate, 3-methoxy butyl acetate, amyl acetate, ethylene glycol ethyl ether acetate, butyl glycol acetate, propylene glycol methyl ether acetate, methyl ethyl ketone, methyl isobutyl ketone, acetone, diisobutyl ketone, isophorone, and cyclohexanol. Specifically, the solvent may include one or more selected from the group consisting of n-butyl acetate, dimethyl glutarate, dimethyl succinate, dimethyl adipate, and propylene glycol methyl ether acetate.

In addition, the solvent may be included in an amount of 5 wt % to 35 wt %, or 7 wt % to 30 wt %, based on the total weight of the base coating composition. If the content of the solvent is in the above-described range, the viscosity of the coating composition is suitable, so that there is an effect in that workability is excellent. In addition, if the content of the solvent is less than the above-described range, there may be a problem in that the coating composition has an insufficient viscosity, and thus, has insufficient workability, and if greater than the above-described range, there may be a problem in that the coating composition has reduced adhesion or an excessive viscosity, and thus, has insufficient workability.

The base coating composition may further include an additive.

### Additive

The additive is not particularly limited as long as it can commonly be applied to a coating paint, but may include, for example, a curing accelerator, an adhesion promoter, a leveling agent, an anti-sedimentation agent, a curing agent, a wax, or the like.

At this time, the additive may be included in an amount of 1 wt % to 20 wt %, or 3 wt % to 13 wt %, based on the total weight of the base coating composition.

The curing accelerator serves to increase the cross-linking density of the coating composition. As the above-described curing accelerator, a curing accelerator commonly used in a coating composition to increase the degree of cross-linking may be used, and for example, the curing accelerator may be a metal compound such as dibutyltin dilaurate, dibutyltin diacetate, stannous octoate, dibutyltin mercaptide, a tertiary amine such as triethylamine, triethanolamine, 1,4-diazocyclooctane, dimethylethanolamine, ethylmorphyrine, dimethylaminoethylmorpholine, and dimethylcyclohexylamine, and a carboxylate or zinc-based complex compound of an alkali metal. The amount of use of the curing accelerator is not particularly limited, and the amount of use thereof may be adjusted as long as there is no influence on physical properties of the composition.

The adhesion promoter serves to improve adhesion between a primer coating film, which is a lower end of a base coating film, and a clear coating film, which is an upper end of the base coating film. As the adhesion promoter, an additive commonly used in a coating composition to adjust interlayer adhesion may be used, and the adhesion promoter may be, for example, a phosphoric acid-modified resin. Specifically, the adhesion promoter may include one or more selected from the group consisting of a phosphoric acid-modified polyester resin and a phosphoric acid-modified epoxy resin.

The leveling agent serves to impart smoothness to the coating composition to improve appearance characteristics of a coating film manufactured therefrom, thereby suppressing the occurrence of orange peel. In addition, the leveling agent can be used without particular limitation as long as it is commonly used in a coating composition, and the leveling agent may be, for example, an ether-modified polysiloxane.

The anti-sedimentation agent serves to prevent the sedimentation of a pigment, thereby improving storage properties of a coating, and improving appearance characteristics of a manufactured coating film. At this time, the anti-sedimentation is not particularly limited as long as it can be used to prevent pigment sedimentation in a coating composition, and may be, for example, an amide wax.

The base coating composition may have a viscosity at 25° C. of 25 seconds to 90 seconds, or 28 seconds to 80 seconds, based on Ford Cup No. 4.

In addition, the base coating composition may include solids in an amount of 5 wt % to 25 wt %, or 8 wt % to 20 wt % solids, based on the total weight of the composition.

As described above, the base coating composition according to the present invention enables spray coating on a large-area complex shape, and thus, has excellent workability and mass productivity, which makes the base coating composition very suitable for coating automobile parts. Furthermore, the base coating composition is capable of implementing various luxurious colors, and may form a coating film having a higher luminance than a typical metallic coating has. In addition, the coating film manufactured from the base coating composition is excellent in various physical properties, such as water resistance, weather resistance, high-pressure car-wash properties, chipping resistance, acid resistance, alkali resistance, and accelerated weather resistance. Particularly, the coating film manufactured from the base paint composition has very excellent appearance characteristics due to less occurrence of defects such as metallic stains, spots, or foreign substances.

### MODE FOR CARRYING OUT THE INVENTION

Hereinafter, the present invention will be described in more detail with reference to examples. However, the following examples are merely illustrative of the present invention and are not intended to limit the scope of the present invention.

### Examples 1 to 18 and Comparative Examples 1 to 4. Preparation of Base Coating Composition

A base coating composition was prepared by mixing components according to the composition described in each of Tables 1 to 4. In Tables 1 to 4, DBE is dibasic ester, PMA is propylene glycol methyl ether acetate, and BA is n-butyl acetate.

TABLE 1

| Component (wt %) | Example 1 | Example 2 | Example 3 | Example 4 | Example 5 | Example 6 | Example 7 |
|---|---|---|---|---|---|---|---|
| Aluminum-based | 8 | 8 | 8 | 8 | 8 | 8 | 8 |
| pigment-1 | | | | | | | |
| Nitrocellulose resin-1 | 50 | 50 | 50 | 50 | 50 | 40 | 60 |
| Acrylic polyol resin-1 | 10 | 10 | 10 | 5 | 12 | 10 | 10 |
| Polyester resin-1 | 5 | 3 | 10 | 5 | 5 | 5 | 5 |
| Curing accelerator | 1 | 1 | 1 | 1 | 1 | 1 | 1 |
| Solvent-1 (DBE) | 2 | 2 | 2 | 2 | 2 | 2 | 2 |
| Solvent-2 (PMA) | 4 | 4 | 4 | 4 | 4 | 4 | 4 |
| Solvent-3 (BA) | 11 | 13 | 6 | 16 | 9 | 21 | 1 |
| Amide wax | 6 | 6 | 6 | 6 | 6 | 6 | 6 |
| Isocyanate | 3 | 3 | 3 | 3 | 3 | 3 | 3 |
| Total amount | 100 | 100 | 100 | 100 | 100 | 100 | 100 |

TABLE 2

| | Example | Example | Example | Example | Example | Example | Example |
|---|---|---|---|---|---|---|---|
| Component (wt %) | 8 | 9 | 10 | 11 | 12 | 13 | 14 |
| Aluminum-based | 5 | 13 | — | — | — | 8 | 8 |
| pigment-1 | | | | | | | |
| Aluminum-based | — | — | 8 | — | — | — | — |
| pigment-2 | | | | | | | |
| Aluminum-based | — | — | — | 8 | — | — | — |
| pigment-3 | | | | | | | |
| Aluminum-based | — | — | — | — | 8 | — | — |
| pigment-4 | | | | | | | |
| Nitrocellulose | 50 | 50 | 50 | 50 | 50 | 50 | 50 |
| resin-1 | | | | | | | |
| Acrylic polyol | 10 | 10 | 10 | 10 | 10 | — | — |
| resin-1 | | | | | | | |
| Acrylic polyol | — | — | — | — | — | 10 | — |
| resin-2 | | | | | | | |
| Acrylic polyol | — | — | — | — | — | — | 10 |
| resin-3 | | | | | | | |
| Polyester | 5 | 5 | 5 | 5 | 5 | 5 | 5 |
| resin-1 | | | | | | | |
| Curing | 1 | 1 | 1 | 1 | 1 | 1 | 1 |
| accelerator | | | | | | | |
| Solvent-1 (DBE) | 2 | 2 | 2 | 2 | 2 | 2 | 2 |
| Solvent-2 (PMA) | 4 | 4 | 4 | 4 | 4 | 4 | 4 |
| Solvent-3 (BA) | 14 | 6 | 11 | 11 | 11 | 11 | 11 |
| Amide wax | 6 | 6 | 6 | 6 | 6 | 6 | 6 |
| Isocyanate | 3 | 3 | 3 | 3 | 3 | 3 | 3 |
| Total amount | 100 | 100 | 100 | 100 | 100 | 100 | 100 |

TABLE 3

| | | Example | Example | Example |
|---|---|---|---|---|
| Component (wt %) | Example 15 | 16 | 17 | 18 |
| Aluminum-based | 8 | 8 | 8 | 8 |
| pigment-1 | | | | |
| Nitrocellulose | — | — | 50 | 50 |
| resin-1 | | | | |
| Nitrocellulose | 50 | — | — | — |
| resin-2 | | | | |
| Nitrocellulose | — | 50 | — | — |
| resin-3 | | | | |
| Acrylic polyol | 10 | 10 | 10 | 10 |
| resin-1 | | | | |
| Polyester | 5 | 5 | — | — |
| resin-1 | | | | |
| Polyester | — | — | 5 | — |
| resin-2 | | | | |
| Polyester | — | — | — | 5 |
| resin-3 | | | | |
| Curing | 1 | 1 | 1 | 1 |
| accelerator | | | | |
| Solvent-1 (DBE) | 2 | 2 | 2 | 2 |
| Solvent-2 (PMA) | 4 | 4 | 4 | 4 |
| Solvent-3 (BA) | 11 | 11 | 11 | 11 |
| Amide wax | 6 | 6 | 6 | 6 |
| Isocyanate | 3 | 3 | 3 | 3 |
| Total amount | 100 | 100 | 100 | 100 |

TABLE 4

| | Comparative | Comparative | Comparative | |
|---|---|---|---|---|
| Component | Example | Example | Example | Comparative |
| (wt %) | 1 | 2 | 3 | Example 4 |
| Aluminum- | 8 | 8 | 8 | 8 |
| based | | | | |
| pigment-1 | | | | |
| Nitrocellulose | 55 | 60 | — | 50 |
| resin-1 | | | | |
| Acrylic polyol | 10 | — | 60 | — |
| resin-1 | | | | |
| Acrylic polyol | — | — | — | 10 |
| resin-4 | | | | |
| (unmodified) | | | | |
| Polyester | — | 5 | 5 | 5 |
| resin-1 | | | | |
| Curing | 1 | 1 | 1 | 1 |
| accelerator | | | | |
| Solvent-1 | 2 | 2 | 2 | 2 |
| (DBE) | | | | |
| Solvent-2 | 4 | 4 | 4 | 4 |
| (PMA) | | | | |
| Solvent-3 | 11 | 11 | 11 | 11 |
| (BA) | | | | |
| Amide wax | 6 | 6 | 6 | 6 |
| Isocyanate | 3 | 3 | 3 | 3 |
| Total amount | 100 | 100 | 100 | 100 |

The physical properties, manufacturer, and product name of each component used in Comparative Examples and Examples are shown in Table 5.

TABLE 5

| | Manufacturer | |
|---|---|---|
| | and product | |
| Component | name | Notes |
| Aluminum-based | — | Polygonal column (height: |
| pigment-1 | | 80 μm, average diameter |
| | | of circumscribed circle |
| | | of polygon at base: 8 μm) |
| Aluminum-based | — | Cylindrical column (height: |
| pigment-2 | | 80 μm, average diameter |
| | | at base: 7 μm) |
| Aluminum-based | — | Polygonal column (height: |
| pigment-3 | | 40 μm, average diameter |
| | | of circumscribed circle |
| | | of polygon at base: 7 μm) |
| Aluminum-based | — | Cylindrical column (height: |
| pigment-4 | | 30 μm, average diameter |
| | | at base: 10 μm) |
| Nitrocellulose | — | Mw: 300,000 g/mol, Mn: |
| (NC) resin-1 | | 30,000 g/mol, NC content: |
| | | 5.5 wt % |
| Nitrocellulose | — | Mw: 200,000g/mol, Mn: |
| resin-2 | | 20,000 g/mol, NC content: |
| | | 4 wt % |
| Nitrocellulose | — | Mw: 400,000g/mol, Mn: |
| resin-3 | | 40,000 g/mol, NC content: |
| | | 7 wt % |
| Acrylic polyol | — | CAB modified acrylic |
| resin-1 | | polyol resin (CAB content: |
| | | 7.5 wt %, OHv: 30 mgKOH/g, |
| | | Av: 7.5 mgKOH/g, Tg: |
| | | 2.5° C., Mw: 125,000 |
| | | g/mol) |
| Acrylic polyol | — | CAB modified acrylic polyol |
| resin-2 | | resin (CAB content: 5 wt %, |
| | | OHv: 40 mgKOH/g, Av: 5 |
| | | mgKOH/g, Tg: 1° C., Mw: |
| | | 100,000 g/mol) |
| Acrylic polyol | — | CAB modified acrylic polyol |
| resin-3 | | resin (CAB content: 10 wt %, |
| | | OHv: 60 mgKOH/g, Av: 10 |
| | | mgKOH/g, Tg: 5° C., Mw: |
| | | 150,000 g/mol) |
| Acrylic polyol | — | Unmodified acrylic polyol |
| resin-4 | | resin (OHv: 40 mgKOH/g, |
| (unmodified) | | Av: 5 mgKOH/g, Tg: 1° C., |
| | | Mw: 150,000 g/mol) |
| Polyester resin-1 | — | Mn: 2,000 g/mol, Tg: |
| | | −15° C., Av: 5 |
| | | mgKOH/g, OHv: 135 mgKOH/g |
| Polyester resin-2 | — | Mn: 1,000 g/mol, Tg: |
| | | −30° C., Av: 1 |
| | | mgKOH/g, OHv: 120 mgKOH/g |
| Polyester resin-3 | — | Mn: 3,000 g/mol, Tg: |
| | | 0° C., Av: 10 mgKOH/g, |
| | | OHv: 150 mgKOH/g |
| Curing accelerator | — | Dibutyltin dilaurate (DBTDL) |
| Amide wax | Manufacturer: | — |
| | Hung San Hwa | |
| | Sung, Product | |
| | name: HPA-405 | |
| Isocyanate | Manufacturer: | |
| | ASAHI KASEI | |
| | CHEMICALS, | |
| | Product name: | |
| | DURANATE K- | |
| | 6000 | |

### Test Example: Evaluation of Physical Properties

A primer coat (Manufacturer: KCC, product name: RP2143(H)-D/GREY) was coated on a substrate, and then naturally dried for 10 minutes to manufacture a primer coating film having a thickness of 12 m. Thereafter, the base coating composition of each of Examples and Comparative Examples was coated thereon and naturally dried for 10 minutes to manufacture a base coating film having a thickness of 5 m. Thereafter, a clear coat (Manufacturer: KCC, product name: UT5800-A-CLEAR)) was coated thereon, and then dried at 80° C. for 30 minutes to manufacture a clear coating film having a thickness of 30 m. Thereafter, physical properties of a final coating film were measured by the following methods, and the results are shown in Table 6.

### (1) Luminance

The luminance of the base coating film was measured by measuring a flop index by using X-RITE MA-98.

### (2) Adhesion

The adhesion was measured by performing a checkerboard method on the final coating film in accordance with the ASTM D3359 tape adhesion test method.

Specifically, the checkerboard method was performed to measure the adhesion. by making 100 square having a size (width×length) of 1 mm×1 mm with a knife on the surface of the final coating film, and then removing the squares by using tape. At this time, the measured adhesion is evaluated as excellent (⊚) if 100% of the 100 squares remain completely attached, good (∘) if 70% to less than 100% thereof remain attached, average (Δ) if 50% to less than 70% thereof remain attached, and poor (x) if less than 50% thereof remain attached.

### (3) Water Resistance

The final coating film was immersed in a constant temperature bath at 40° C. for 10 days, and then the adhesion was determined by the checkerboard method in the same manner as in Item (2). At this time, the same evaluation criteria were also applied.

### (4) Accelerated Weather Resistance

The weather resistance was measured according to ISO 105 by using a CI-5000 device. At this time, the total amount of irradiation energy was set to 2500 KJ, and the irradiation intensity was set to 0.75 W, and quartz was used an inner filter, and borosilicate of Type S was used as an outer filter.

### (5) High-Pressure Car-Wash Properties

The degree of peeling of the coating film was confirmed by making an X-shaped crosscut with a knife on the final coating, and then spraying high-pressure water at a pressure of 70 kgf from a distance of 10 cm onto the final coating film by using a commercial high-pressure car wash machine (including a nozzle gun with a gun tip angle of 15°).

At this time, if there was no area of a detached coating film, it was evaluated as excellent (⊚), if the area of a detached coating film around the crosscut was less than 3 area % of the total area, it was evaluated as good (∘), if the area of a detached coating film was 3 area % to less than 5 area %, it was evaluated as average (A), and if the area of a detached coating film was 5 area % or greater, it was evaluated as poor (x).

### (6) Workability

The workability was measured by manufacturing a base coating film as described above on a specimen in a size of 30 cm×30 cm (width×height), and then observing the appearance and stains on the surface of the coating film with the naked eye.

At this time, if there were no stains, spots, or foreign substances, it was evaluated as excellent (⊚), if there were fine stains, spots, or foreign substances identified, it was evaluated as good (∘) if there were fine stains, spots, or foreign substances identified when observed at a distance of 1 m, it was evaluated as average (A), and if there were stains, spots, or foreign substances clearly identified, it was evaluated as poor (x).

TABLE 6

| | | | | Accelerated | High-pressure | |
|---|---|---|---|---|---|---|
| | | | Water | weather | car-wash | |
| Items | Luminance | Adhesiveness | resistance | resistance | properties | Workability |
| Example 1 | 26.5 | ⊚ | ⊚ | ⊚ | ⊚ | ⊚ |
| Example 2 | 26.5 | ◯ | ◯ | ◯ | ◯ | ◯ |
| Example 3 | 26.5 | ◯ | ◯ | ◯ | ◯ | ◯ |
| Example 4 | 25 | ◯ | ◯ | ◯ | ◯ | ◯ |
| Example 5 | 26.5 | ◯ | ◯ | ◯ | ◯ | ◯ |
| Example 6 | 26.5 | ◯ | ◯ | ◯ | ◯ | ◯ |
| Example 7 | 26.5 | ◯ | ◯ | ◯ | ◯ | ◯ |
| Example 8 | 22 | ⊚ | ⊚ | ⊚ | ⊚ | ⊚ |
| Example 9 | 25 | ⊚ | ⊚ | ⊚ | ⊚ | ⊚ |
| Example 10 | 26.5 | ⊚ | ⊚ | ⊚ | ⊚ | ⊚ |
| Example 11 | 26.5 | ⊚ | ⊚ | ⊚ | ⊚ | ⊚ |
| Example 12 | 26.5 | ⊚ | ⊚ | ⊚ | ⊚ | ⊚ |
| Example 13 | 22 | ◯ | ⊚ | ⊚ | ⊚ | ⊚ |
| Example 14 | 27 | ⊚ | ⊚ | ⊚ | ⊚ | ◯ |
| Example 15 | 25 | ◯ | ⊚ | ⊚ | ⊚ | ⊚ |
| Example 16 | 22 | ⊚ | ⊚ | ⊚ | ⊚ | ⊚ |
| Example 17 | 22 | ⊚ | ⊚ | ⊚ | ⊚ | ⊚ |
| Example 18 | 25 | ⊚ | ⊚ | ⊚ | ⊚ | ◯ |
| Comparative | 25 | Δ | ◯ | ◯ | Δ | X |
| Example 1 | | | | | | |
| Comparative | 5 | ◯ | Δ | Δ | ◯ | X |
| Example 2 | | | | | | |
| Comparative | 15 | Δ | Δ | Δ | Δ | X |
| Example 3 | | | | | | |
| Comparative | 15 | ◯ | ◯ | ◯ | ◯ | Δ |
| Example 4 | | | | | | |

As confirmed from the results in Table 6 above, the coating film of each of Examples 1 to 18 according to the present invention exhibited overall excellent physical properties in the measurement items.

On the other hand, Comparative Example 1, in which the polyester resin was not applied, was overall poor in adhesion, high-pressure car-wash properties, and workability. In addition, Comparative Example 2, in which an acrylic resin was not applied, was poor in luminance, water resistance, accelerated weather resistance, and workability. Furthermore, Comparative Example 3, in which a nitrocellulose resin was not applied, was overall poor in luminance, adhesion, water resistance, accelerated weather resistance, high-pressure car-wash properties, and workability. In addition, Comparative Example 4, in which the acryl polyol resin-4, which is an unmodified acrylic resin, was applied, was poor in luminance and workability.

1. A base coating composition comprising an acrylic polyol resin, a polyester resin, a nitrocellulose resin, and a pigment.

2. The base coating composition of claim 1, wherein the polyester resin has a number average molecular weight of 800 g/mol to 5,000 g/mol, a glass transition temperature of 0° C. or lower, and an acid value of 1 mgKOH/g to 30 mgKOH/g.

3. The base coating composition of claim 1, wherein the acrylic polyol resin is a cellulose acetate butyrate (CAB)-modified acrylic resin, and has a hydroxyl value of 30 mgKOH/g to 80 mgKOH/g, a glass transition temperature of 1° C. to 20° C., and a weight average molecular weight of 100,000 g/mol to 200,000 g/mol.

4. The base coating composition of claim 1, wherein the nitrocellulose resin has a weight average molecular weight of 100,000 g/mol to 500,000 g/mol, and a number average molecular weight of 10,000 g/mol to 50,000 g/mol.

5. The base coating composition of claim 1, wherein the pigment is cylindrical columnar or polygonal columnar in shape, and comprises an aluminum-based pigment having a height of 10 m to 150 m.

6. The base coating composition of claim 1, comprising 5 wt % to 15 wt % of the acrylic polyol resin, 1 wt % to 20 wt % of the polyester resin, 30 wt % to 60 wt % of the nitrocellulose resin, and 1 wt % to 15 wt % of the pigment.
